(19) United States
(12) Patent Application Publication
(10) Pub. No.: US 2006/0139459 A1
(43) Pub. Date: Jun. 29, 2006

(54) Digital camera with a detachable display usable as remote control

(76) Inventor: Qingming Jimmy Zhong, Shanghai (CN)

Correspondence Address: PHILIPS INTELLECTUAL PROPERTY & STANDARDS, P.O. BOX 3001, BRIARCLIFF MANOR, NY, 10510, US

(21) Appl. No.: 10/537,597

(22) PCT Filed: Dec. 2, 2003
(86) PCT No.: PCT/IB03/05579

§ 371 Date: Dec. 5, 2005

(30) Foreign Application Priority Data
Dec. 9, 2002 (CN) 02156125.7

(51) Int. Cl. H04N 5/232

(52) U.S. Cl. 348/211.2

(57) ABSTRACT

The present invention provides an improved digital camera that enables a user to conveniently and accurately record video or pictures of the user himself. In one embodiment of the invention, a digital camera comprises a camera body and a display panel detachably connected to the camera body. The display panel includes a remote control circuit that is configured to wirelessly operate the camera, so that a user can record any contents seen in the display panel. In another embodiment of the invention, the camera further includes a motor attached to the camera body, and the remote control circuit controls the motor to focus the lens on a desired subject. The remote control circuit includes a wireless communication interface that supports at least one of the following protocols: Bluetooth, Zigbee, IEEE 802.11 and infrared. The invention is applicable to both digital video and still cameras.

### BACKGROUND OF THE INVENTION

The invention relates generally to consumer electronics, and more particularly to digital cameras with a detachable display used as a remote control to operate the camera.

Digital cameras, both video and still, have been very popular nowadays. People can take the advantages of digital cameras to record favorite scenes and pictures and share them with others. A traditional digital camera usually requires a person to act as the photographer to hold and operate the camera to take video or still pictures on other people or subjects. In the case where one would like to take video or pictures of himself, he would need to make an estimate of the focus of the camera lens and then use a remote control unit of the camera to record. Oftentimes, such an estimate is very rough and the subject in the resulting video or picture is not in a desired position. Further, it involves a number of adjustments in order to obtain acceptable video or pictures. Making the adjustments back and forth gives much inconvenience and hassles to users such that this feature of the camera is rarely used by many users.

Therefore, there is a need for an improved digital camera that allows a user to be able to conveniently and accurately record video or pictures of the user himself.

### SUMMARY OF THE INVENTION

The present invention provides an improved digital camera that enables a user to conveniently and accurately record video or pictures of the user himself. The invention is applicable to both digital video and still cameras.

In one embodiment of the invention, a digital camera comprises a camera body and a display panel detachably connected to the camera body. The display panel includes a remote control circuit that is configured to wirelessly operate the camera, so that a user can record any contents seen in the display panel.

In another embodiment of the invention, the camera further includes a motor attached to the camera body, and the remote control circuit controls the motor to focus the lens on a desired subject. The remote control circuit includes a wireless communication interface that supports at least one of the following protocols: Bluetooth, Zigbee, IEEE 802.11 and infrared.

Other objects and attainments together with a fuller understanding of the invention will become apparent and appreciated by referring to the following description and claims taken in conjunction with the accompanying drawings.

### BRIEF DESCRIPTION OF THE DRAWINGS

The invention is explained in further detail, and by way of example, with reference to the accompanying drawings wherein:

FIG. 1 illustrates a digital camera in accordance with one embodiment of the invention;

FIG. 2 shows a display panel in accordance with one embodiment of the invention; and

FIG. 3 is a functional block diagram of a display panel in accordance with one embodiment of the invention.

Throughout the drawings, the same reference numerals indicate similar or corresponding features or functions.

### DETAILED DESCRIPTION OF THE PREFERRED EMBODIMENTS

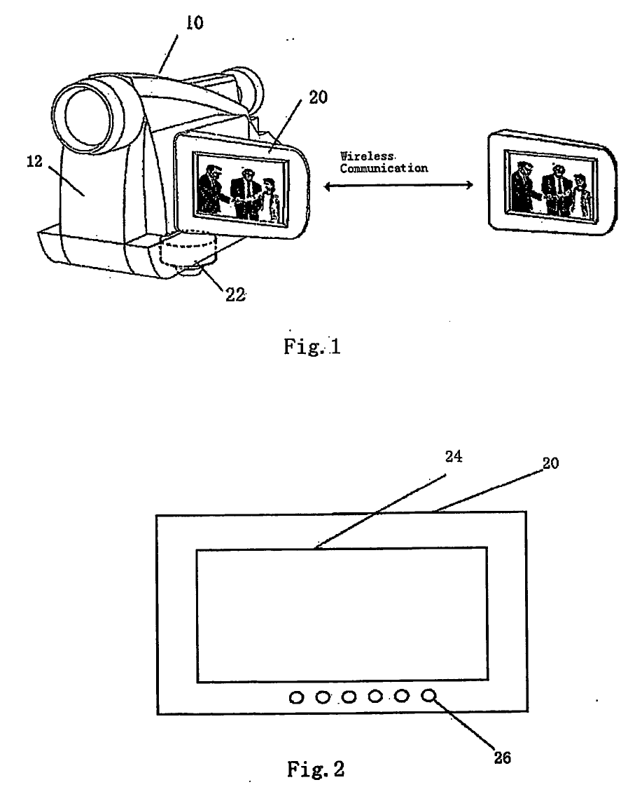

FIG. 1 illustrates a digital camera 10 in accordance with one embodiment of the invention. Camera 10 includes a camera body 12, a detachable display panel 20, e.g., a LCD panel, and a motorized unit 22. Display panel 20 includes remote control circuitry for wirelessly controlling the operation of camera 10 when it is detached from the camera body. When it is attached to the camera body, display panel 20 functions as a normal display and camera 10 returns to a normal operation mode. Motorized unit 22 includes a small motor that can change the direction of the camera body to focus the camera lens on a subject, in response to control signals wirelessly received from display panel 20.

FIG. 2 shows display panel 20 in accordance with one embodiment of the invention. Display panel 20 has a LCD display 24 and a plurality of control buttons 26 for remotely controlling the operation of camera 10, e.g., to record video and play back the video previously taken. LCD display 24 may be a touch screen, so that control buttons 26 may be implemented on the display itself.

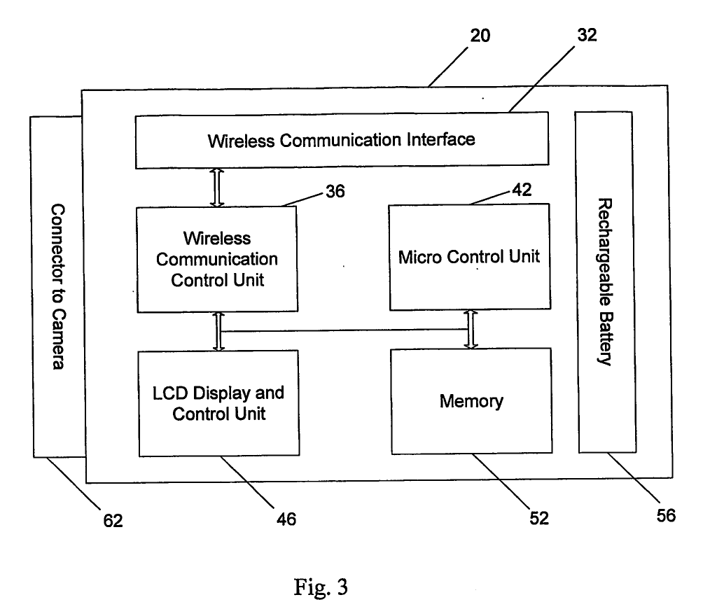

FIG. 3 is a functional block diagram of display panel 20 in accordance with one embodiment of the invention. As illustrated, display panel 20 includes a wireless communication interface 32, a wireless communication control unit 36, a micro control unit 42, a LCD display and control unit 46 and a memory 52. Display panel also includes a rechargeable battery 56 and a connector 62 for connecting to camera body 12. Wireless communication interface 32 can support various protocols, e.g., Bluetooth, Zigbee, IEEE 802.11, infrared, etc.

When a user wants to record video of himself, he can place camera 10 on a tripod and detach display panel 20 from camera body 12. Then he can operate the remote control buttons on the display panel to focus the lens on himself. If he likes what he sees on the display, he can simply record it. He may also make appropriate adjustments by changing the direction and level of the camera lens and then record it. He may even move around and control the camera lens to focus on himself while he is moving around and record the whole event. Alternatively, the user may use camera 10, as a monitoring system, to monitor movable subjects, e.g., a child, a pet, etc. In this way, a user can accurately record himself or anything without having another dedicated person physically holding and operating the camera.

In the above, a video camera is used as an example to illustrate one embodiment of the invention. In another embodiment of the invention, a still digital camera may be remotely controlled by a detachable display panel in a similar way.

While the invention has been described in conjunction with specific embodiments, it is evident that many alternatives, modifications and variations will be apparent to those skilled in the art in light of the foregoing description. Accordingly, it is intended to embrace all such alternatives, modifications and variations as fall within the spirit and scope of the appended claims.

What is claimed is:

1. A digital camera, comprising:
a camera body; and
a display panel detachably connected to the camera body, the display panel including a remote control circuit that is configured to wirelessly operate the camera.

2. The camera of claim 1, wherein the camera body includes a lens and the display panel displays contents seen by the lens.

3. The camera of claim 1, further comprising a motor attached to the camera body, wherein the remote control circuit controls the motor to adjust the direction and level of the camera body.

4. The camera of claim 3, wherein the camera body includes a lens and the remote control circuit controls the motor to focus the lens on a desired subject.

5. The camera of claim 1, wherein the remote control circuit includes a wireless communication interface.

6. The camera of claim 5, wherein the interface supports at least one of the following protocols: Bluetooth, Zigbee, IEEE 802.11 and infrared.

7. The camera of claim 1, wherein the display panel includes a touch screen and a plurality of control button on the touch screen for operating the remote control circuit to control the camera body.

8. The camera of claim 1, wherein the camera body is configured to record video contents.

9. The camera of claim 1, wherein the camera body is configured to record still images.

10. A digital camera, comprising:
a camera body having a lens; and
a display panel detachably connected to the camera body, the display panel displaying contents seen in the lens and including a remote control circuit that is configured to wirelessly operate the camera, the remote control circuit including a wireless communication interface;
wherein the remote control circuit is operable to record contents seen on the display panel.

11. The camera of claim 10, further comprising a motor attached to the camera body, wherein the remote control circuit controls the motor to adjust the camera body to focus the lens on a desired subject.

12. The camera of claim 11, wherein the interface supports at least one of the following protocols: Bluetooth, Zigbee, IEEE 802.11 and infrared.

13. The camera of claim 10, wherein the display panel includes a touch screen and a plurality of control button on the touch screen for operating the remote control circuit to control the camera body.

14. The camera of claim 10, wherein the camera body is configured to record video contents.

15. The camera of claim 10, wherein the camera body is configured to record still images.
